(19) United States
(12) Patent Application Publication
(10) Pub. No.: US 2021/0359959 A1
(43) Pub. Date: Nov. 18, 2021

(54) SHARED NETWORK PROCESSING UNIT

(71) Applicant: QUALCOMM Incorporated, San Diego, CA (US)

(72) Inventors: Nicola VARANESE, Nuremberg (DE); Puneet SETHI, San Diego, CA (US); Bjorn BJERKE, Concord, MA (US)

(21) Appl. No.: 17/142,437

(22) Filed: Jan. 6, 2021

Related U.S. Application Data
(60) Provisional application No. 63/023,835, filed on May 12, 2020.

(51) Int. Cl. H04L 12/931; H04W 24/02; H04W 24/08; H04W 84/04; G06F 9/455

(52) U.S. Cl. CPC H04L 49/70; H04W 24/02; G06F 2009/45595; H04W 84/042; G06F 9/45558; H04W 24/08

(57) ABSTRACT

Embodiments include methods for managing communications that may be performed by a processor of a shared network processing unit (NPU). The processor may present to each of a plurality of network controller devices an interface to a corresponding one of a plurality of virtual NPU modules each executing within a container within a virtualization platform, wherein each virtual NPU module enables one of the plurality of network controller devices to communicate with a corresponding one of a plurality of small cells. The processor may direct, via a virtual switch executing on the virtualization platform, communications between each of the plurality of network controller devices and a corresponding one of the plurality of virtual NPU modules and between each of the plurality of virtual NPU modules and a corresponding one of the plurality of small cells.

### RELATED APPLICATIONS

This application claims the benefit of priority of U.S. Provisional Application No. 63/023,835 entitled “Shared Network Processing Unit” filed May 12, 2020, the entire contents of which are incorporated herein by reference.

### BACKGROUND

Cellular communication signals are severely attenuated or blocked by building structures, among other things, creating challenges for providing wireless communications within concert and sport venues, train stations, industrial facilities, and the like. Some of the issues of building penetration can be addressed by deploying a distributed antenna system (DAS) within the building. However, the typical DAS deployment is cost effective for large venues, but quickly becomes impractical for smaller venues. Further, 5G New Radio (NR) systems use frequency bands in the millimeter wave frequency bands, which provide even poorer structural penetration than previous wireless communication systems.

### SUMMARY

Various aspects may include systems and methods for managing communications performed by a shared network processing unit (NPU) configured to enable communication between multiple network operators and base stations (such as small cells) associated with a respective network operator. Various aspects may be particularly useful for in-building communication systems and/or for use as part of a distributed antenna system. Various aspects may include presenting to each of a plurality of network controller devices an interface to a corresponding one of a plurality of virtual NPU modules each executing within a container within a virtualization platform, wherein each virtual NPU module enables one of the plurality of network controller devices to communicate with a corresponding one of a plurality of small cells, and wherein each virtual NPU module provides to each corresponding network controller device functionality that includes translation of packet payload information between a first packet format for each of the plurality of network controller devices and a second packet format for a corresponding one of the plurality of small cells, and directing, via a virtual switch, communications between each of the plurality of network controller devices and a corresponding one of the plurality of virtual NPU module and between each of the plurality of virtual NPU modules and a corresponding one of the plurality of small cells.

In some aspects, directing, via a virtual switch, communications between each of the plurality of network controller devices and the corresponding one of the plurality of virtual NPU modules and between each of the plurality of virtual NPU modules and the corresponding one of the plurality of small cells may include receiving data plane or control plane traffic from one of the plurality of network controller devices via a first network interface, processing the data plane or control plane traffic via a fronthaul interface in the one of the plurality of virtual NPU modules corresponding to that network controller device, and directing via the virtual switch the data plane or control plane traffic from the one of the plurality of network controller devices to the corresponding one of the plurality of small cells associated with the virtual NPU module via a second network interface.

In some aspects, directing, via the virtual switch, communications between each of the plurality of network controller devices and the corresponding one of the plurality of virtual NPU modules and between each of the plurality of virtual NPU modules and the corresponding one of the plurality of small cells further may include receiving management plane traffic from one of the plurality of network controller devices via a first network interface, processing the management plane traffic via an operations, administration and management (OAM) interface in the one of the plurality of virtual NPU modules corresponding to that network controller device, and directing via the virtual switch the management plane traffic from the one of the plurality of network controller devices to the corresponding one of the plurality of small cells associated with the virtual NPU module via a second network interface.

In some aspects, directing via a virtual switch communications between each of the plurality of network controller devices and the corresponding one of the plurality of virtual NPU modules and between each of the plurality of virtual NPU modules and the corresponding one of the plurality of small cells may include receiving user equipment data from the corresponding one of the plurality of small cells, processing user equipment message data in the one of the plurality of virtual NPU modules associated with the corresponding one of the plurality of small cells, and directing the user equipment message data from the one of the plurality of virtual NPU modules to the corresponding one of the plurality of network controller devices via a first network interface.

Various aspects may include a shared NPU that includes a first network port configured to provide first network interface for data and command messages to a plurality of network operators, a second network port configured to provide a second network interface for data and command messages to each of a plurality of small cells, and a processor configured with processor-executable instructions to perform operations that may include providing a virtualization platform coupled to the first and second network ports, executing a plurality of virtual network processing unit (NPU) modules, each of the plurality of virtual NPU modules providing network processing unit functionality for a corresponding one of the plurality of network operators, wherein each of the plurality of virtual NPU modules executes within a container within the virtualization platform, and wherein the network processing unit functionality includes translation of packet payload information between a first packet format for each of the plurality of network operators and a second packet format for a corresponding one of the plurality of small cells, and executing a virtual switch configured to pass message data and control information between each of the plurality of network operators and a corresponding one of the plurality of network processing unit modules via the first network interface and to pass message data or control information between each of the plurality of network processing unit modules and a corresponding one of a plurality of small cells via the second network interface.

In some aspects, the processor may be further configured with processor-executable instructions to perform operations such that executing each of the plurality of network processing unit modules may include executing an operations, administration and management (OAM) interface configured to convey management plane traffic between a corresponding network operator and a corresponding small cell, and executing a fronthaul interface configured to convey data plane and control plane traffic between the corresponding network operator and the corresponding small cell. In some aspects, the processor may be further configured with processor-executable instructions to perform operations such that each fronthaul interface and OAM interface executes within a container within the virtualization platform. In some aspects, the first network port may be an Ethernet port configured to be coupled to a plurality of network operators via an external network. In some aspects, the second network port may be at least one PCIe port configured to be coupled to a plurality of small cells.

In some aspects, the processor may be further configured with processor-executable instructions to perform operations including receiving data plane or control plane traffic from one of the plurality of network operators via the first network interface, processing the data plane or control plane traffic via the fronthaul interface in one of the plurality of virtual NPU modules corresponding to that network operator, and directing via the virtual switch the data or control plane traffic from the one of the plurality of network operators to the corresponding one of the plurality of small cells associated with the virtual NPU module via the second network interface.

In some aspects, the processor may be further configured with processor-executable instructions to perform operations including receiving management plane traffic from one of the plurality of network operators via the first network interface, processing the management plane traffic via the OAM interface in one of the plurality of virtual NPU modules corresponding to that network operator, and directing via the virtual switch the data or control plane traffic from the one of the plurality of network operators to the corresponding one of the plurality of small cells associated with the virtual NPU module via the second network interface.

In some aspects, the processor may be further configured with processor-executable instructions to perform operations including receiving user equipment message data from the corresponding one of the plurality of small cells, processing the user equipment message data in the one of the plurality of virtual NPU modules associated with the corresponding one of the plurality of small cells; and directing the user equipment message data from the one of the plurality of virtual NPU modules to a corresponding network controller device one of the plurality of network operators via the first network interface.

Further aspects may include a shared network processing unit having a processor configured to perform one or more operations of any of the methods summarized above. Further aspects may include processing devices for use in a shared network processing unit configured with processor-executable instructions to perform operations of any of the methods summarized above. Further aspects may include a non-transitory processor-readable storage medium having stored thereon processor-executable instructions configured to cause a processor of a shared network processing unit to perform operations of any of the methods summarized above. Further aspects include a shared network processing unit having means for performing functions of any of the methods summarized above. Further aspects include a system on chip for use in a shared network processing unit that includes a processor configured to perform one or more operations of any of the methods summarized above. Further aspects include a system in a package that includes two systems on chip for use in a shared network processing unit that includes a processor configured to perform one or more operations of any of the methods summarized above.

### BRIEF DESCRIPTION OF THE DRAWINGS

FIG. 1 is a system block diagram illustrating an example communications system suitable for use with various embodiments.

FIGS. 2 and 3 are component block diagrams illustrating an example distributed antenna system using a virtual radio access network (RAN) architecture suitable for use with various embodiments.

FIG. 4 is a component block diagram illustrating an example network processing unit (NPU) architecture suitable for use with various embodiments.

FIG. 5 is a process flow diagram illustrating a method performed by a processor of an NPU for managing communications according to various embodiments.

FIGS. 6A, 6B, and 6C are process flows diagrams illustrating operations that may be performed by a processor of an NPU as part of the method for managing communications according to various embodiments.

FIG. 7 is a component block diagram of a network computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The term “small cell” is used herein to refer to a wireless access point, typically for a cellular communication system, that is physically smaller than a macro base station and/or provides coverage for an area smaller than a macro base station. A small cell may include any of a micro cell, a pico cell, a femto cell, or any other suitable device that provides similar functions. In some implementations, a small cell may communicate with a macro cell and/or with a communication network via a wired or wireless backhaul communication link.

The terms “wireless device” and “user equipment” are used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (e.g., ROM, RAM, Flash, etc.), and resources (e.g., timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As noted above, building structures tend to attenuate or block cellular communication signals. This challenge is readily apparent in 5G NR systems that provide higher bandwidth communication channels in part by using millimeter wave (mmWave) frequency bands. To address these challenges, a distributed antenna system (DAS) may be deployed, especially with within large concert and sport venues, train stations, industrial facilities, and the like, to provide in-building access to a communication network. An in-building DAS may use a plurality of small cells as network access points. In areas serviced by multiple network operators, each network operator may deploy a DAS within the venue. The typical DAS deployment may be cost effective for large venues, but can quickly become impractical for smaller venues.

Various aspects may include systems and methods for managing communications performed by a shared network processing unit (NPU) configured to enable communication between multiple network operators and base stations (such as small cells) associated with a respective network operator. A multi-operator radio unit may include a plurality of small cells (which may be, in some implementations, operated by more than one network operator) within a single physical enclosure. In various embodiments, the radio unit may include a shared network processing unit (NPU) coupled to each of the plurality of small cells. Other components of the small cells, such as a baseband processor (BBP), radio frequency integrated circuit (RFIC), a radio frequency front end (RFFE), and other components such as internal communication links, power supply, etc., may be reduced in size and/or complexity.

Various embodiments may include the shared NPU presenting to each of a plurality of network controller devices (i.e., of different network operators) an interface to a corresponding one of a plurality of virtual NPU modules each executing within a container within a virtualization platform. Each virtual NPU module may enable one of the plurality of network controller devices to communicate with a corresponding one of a plurality of small cells (i.e., that network operator's associated small cells). Each virtual NPU module may provide to each corresponding network controller device functionality that includes translation of packet payload information between a first packet format for each of the plurality of network controller devices and a second packet format for a corresponding one of the plurality of small cells. The shared NPU may direct, via a virtual switch, communications between each of the plurality of network controller devices and a corresponding one of the plurality of virtual NPU module and between each of the plurality of virtual NPU modules and a corresponding one of the plurality of small cells.

In some embodiments, the shared NPU may receive message data or control information from one of the plurality of network controller devices via a first network interface, process the message data or control information in the one of the plurality of virtual NPU modules corresponding to that network controller device, and direct via the virtual switch the processed message data or control information from the one of the plurality of network controller devices to the corresponding one of the plurality of small cells associated with the virtual NPU module via a second network interface. In some embodiments, the shared NPU also may direct the message data or control information to the corresponding one of the plurality of small cells via a corresponding fronthaul interface.

In some embodiments, the shared NPU may receive user equipment data from the corresponding one of the plurality of small cells, process user equipment message data in the one of the plurality of virtual NPU modules associated with the corresponding one of the plurality of small cells, and direct the user equipment message data from the one of the plurality of virtual NPU modules to the corresponding one of the plurality of network controller devices via the first network interface. In some aspects, the virtual NPU module may provide for each small cell an OAM (operations, administration and management) interface and a fronthaul interface executing within a container running on the virtualization platform.

In various embodiments, the shared NPU may include a first network port configured to provide a communication interface (a first network interface) to a plurality of network operators, a second network port configured to provide a communication interface (a second network interface) to each of a plurality of small cells, and a processor configured with processor-executable instructions to perform operations that may include providing a virtualization platform coupled to the first and second network ports, executing a plurality of NPU modules, each of the plurality of NPU modules providing network processing unit functionality for a corresponding one of the plurality of network operators. Each of the plurality of virtual NPU modules may execute within a container within the virtualization platform. The network processing unit functionality may include translation of packet payload information between a first packet format for each of the plurality of network operators and a second packet format for a corresponding one of the plurality of small cells. The processor-executable instructions may perform operations that also include executing a virtual switch configured to pass message data or control information between each of the plurality of network operators and a corresponding one of the plurality of network processing unit modules via the first network interface, and to pass message data or control information between each of the plurality of network processing unit modules and a corresponding one of a plurality of small cells via the second network interface. In some aspects, the first network port may be an Ethernet port configured to be coupled to a plurality of network operators via an external network. In some aspects, the second network port may be at least one PCIe port configured to be coupled to a plurality of small cells.

In some embodiments, the processor is may be further configured with processor-executable instructions to perform operations such that executing each of the plurality of network processing unit modules may include executing for each small cell an operations, administration and management (OAM) interface configured to convey management plane traffic and a fronthaul interface configured to convey data plane and control plane traffic between each small cell and a corresponding provide an interface for message data or control information between the OAM interface module and the corresponding small cell. In some aspects, the processor may be further configured with processor-executable instructions to perform operations such that each fronthaul interface and OAM interface execute within a container.

Various embodiments improve the operations of a wireless communication system and communication network access points (such as small cells) by increasing the efficiency of communication operations of the wireless communication system and network access points. Various embodiments improve the operations of a wireless communication system by increasing access for wireless communication devices to the wireless communication system.

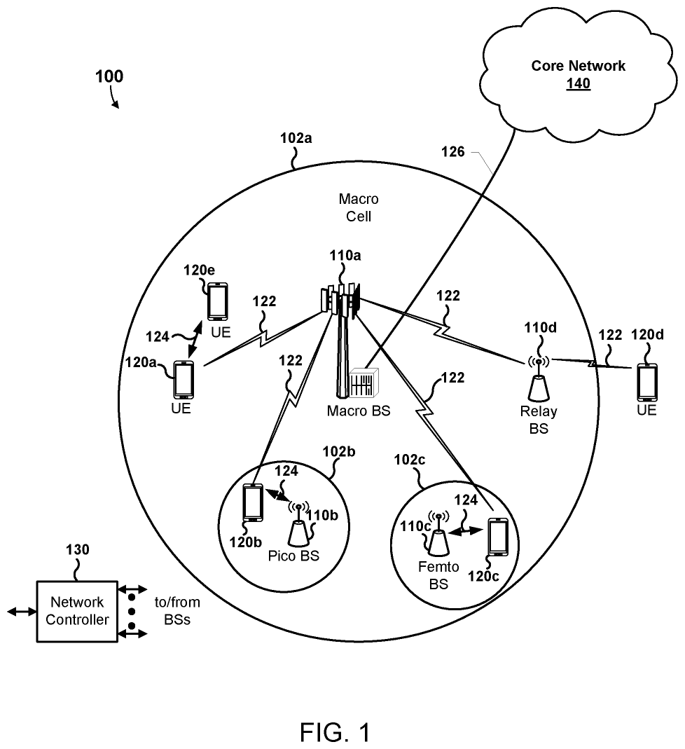

FIG. 1 shows a system block diagram illustrating an example communications system. The communications system 100 may be an 5G NR network, or any other suitable network such as an LTE network.

The communications system 100 may include a heterogeneous network architecture that includes a core network 140 and a variety of wireless devices (illustrated as wireless device 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “computing platform B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network computing platforms (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported.

Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more wireless devices (for example, illustrated as the wireless device 120a and the wireless device 120e) may communicate directly using one or more sidelink channels (for example, without using a base station 110a-d as an intermediary to communicate with one another). For example, the wireless devices 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

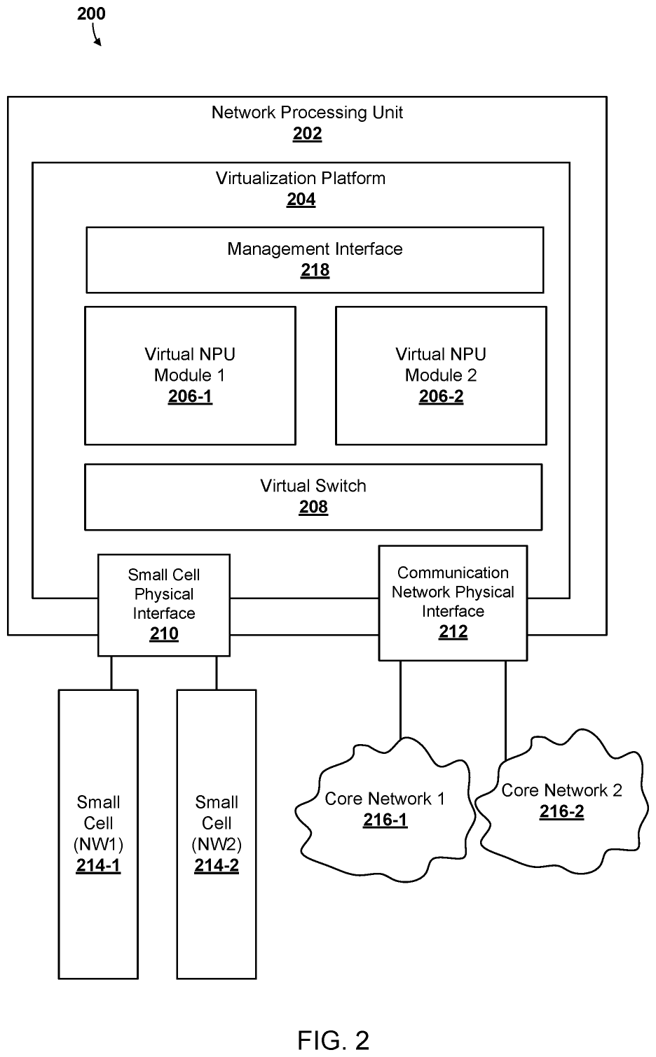

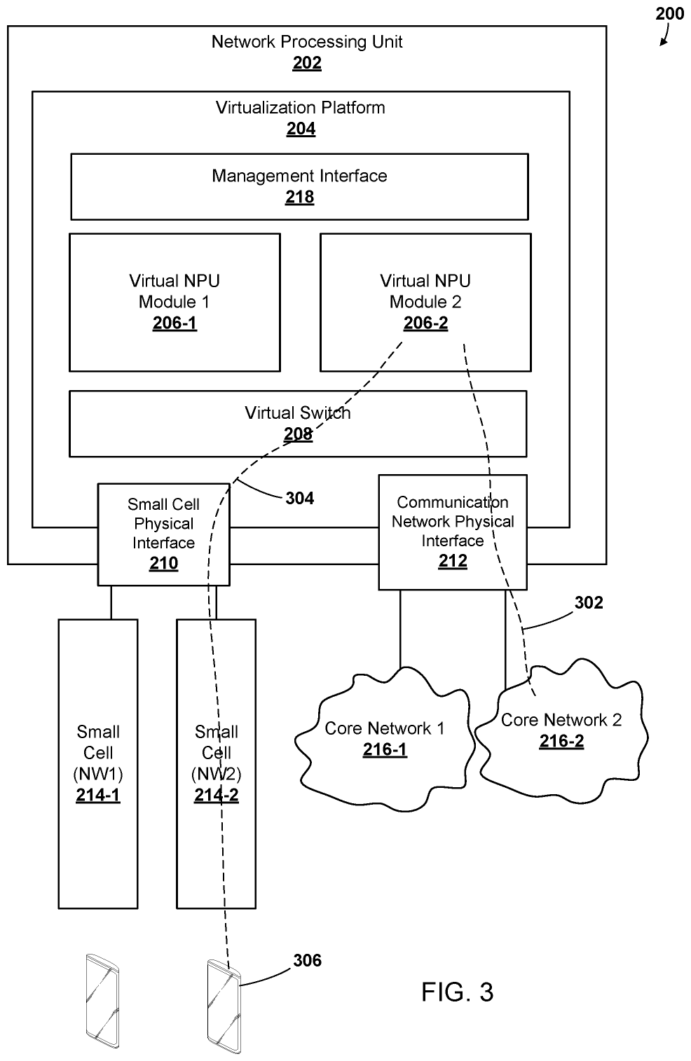

FIGS. 2 and 3 are component block diagrams illustrating an example distributed antenna system 200 using a virtual radio access network (RAN) architecture suitable for use with various embodiments. With reference to FIGS. 1-3, a shared network processing unit (NPU) 202 may enable communication between a first core network 216-1 and a small cell 214-1 corresponding to (deployed by, associated with) the first core network 216-1. The shared NPU also may enable communication between a second core network 216-2 and a small cell 214-2 corresponding to (deployed by, associated with) the second core network 216-2. The shared NPU 202 may run (execute) a virtualization platform 204. The virtualization platform 204 enables the execution (instantiation) of virtual NPU modules 206-1, 206-2, and a virtual switch 208. The shared NPU 202 may include a small cell physical interface 210 to enable communication between the shared NPU 202 and the small cells 214-1, 214-2. The shared NPU 202 also may include a communication network physical interface 212 to enable communication between the shared NPU 202 and the core networks 216-1, 216-2.

The virtual NPU modules 206-1, 206-2 may enable communication between a core network and the core network's small cells. For example, the core network 216-2 may communicate with the virtual NPU module 206-2 via the communication network physical interface 212 along a communication path 302. The virtual switch 208 may direct communications (which may include any of control messages, data messages, commands, requests, and other suitable information, etc.) between the core network 216-2 and the appropriate virtual NPU module (in this case, the virtual NPU module 206-2) via the communication network physical interface 212. The virtual NPU module 206-2 may communicate with one or more small cells associated with the core network 216-2, such as the small cell 214-2, along a communication path 304, via the small cell physical interface 210. The virtual switch 208 may direct communications between the virtual NPU module 206-2 and the small cell 214-2 via the small cell physical interface 210.

The shared NPU 202 may include a management interface 218 that enables access to and control of various aspects and operations of the shared NPU. In some embodiments, the management interface 218 may be instantiated in the virtualization platform 204. In some embodiments, an operator of a core network (such as the first core network 216-1 or the second core network 216-2) or another entity (such as a third-party operator or infrastructure provider, not illustrated) may access and control various hardware and software operations of the network processing unit 202 via the management interface 218. In some embodiments, the third-party operator may include a tower company or provider, and infrastructure company or provider, or a neutral host of any kind, including any entity that may provide a mobile network operator with hosting or infrastructure leasing services.

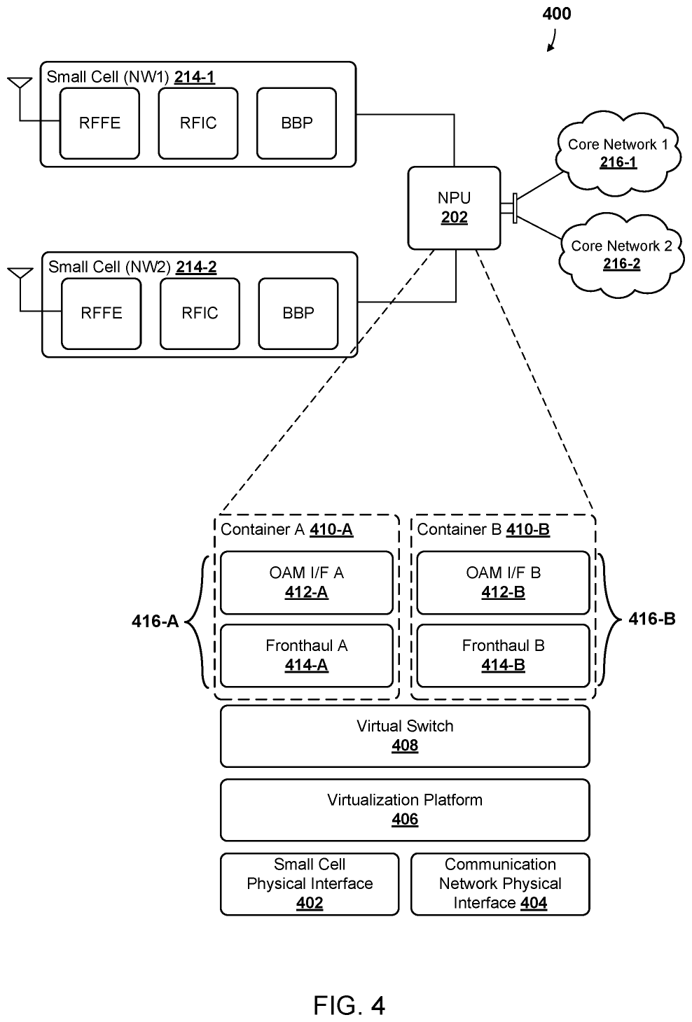

FIG. 4 is a component block diagram illustrating an example network processing unit (NPU) architecture 400 suitable for use with various embodiments. The shared NPU 404 may be configured with a small cell physical interface 402 (e.g., 210) that enables communication with small cells 214-1, 214-2, and with a communication network physical interface 404 (e.g., 212) that enables communication with core networks 216-2, 216-2. In some embodiments, the small cell physical interface 402 may include at least one PCIe port configured to be coupled to the small cells 214-1, 214-2. In some embodiments, the communication network physical interface 404 may include an Ethernet port configured to be coupled to the networks of the network operators (i.e., core networks 216-2, 216-2), for example, via an external network.

The shared NPU 202 may include at least one processor configured to execute a virtualization platform 406 and a virtual switch 408. The virtualization platform 406 may enable the instantiation of a plurality of virtual NPU modules 416-A, 416-B executing on the virtualization platform 406. In some embodiments, each virtual NPU module may run in a container 410-A, 410-B. Each container may execute on (or within) the virtualization platform 406. In various embodiments, each container 410-A, 410-B may function as abstraction layer that packages software and enables the execution of the packaged software in isolation (e.g., from other software executing in other containers). Multiple containers 410-A, 410-B can run on a processor of the shared NPU 202, and may share other resources such as an operating system kernel with other containers. The virtual NPU module 416-A, 416-B running in each container 410-A, 410-B may execute within the container 410-A, 410-B an operations, administration and management (OAM) interface module 412-A, 412-B to convey management plane traffic between a small cell 214-1, 214-2 and a corresponding core network 216-2, 216-2. Each virtual NPU module 416-A, 416-B also may execute a fronthaul 414-A, 414-B within the container 410-A, 410-B to convey data plane and/or control plane traffic between a small cell fronthaul 214-1, 214-2 and a corresponding core network 216-1, 216-2. In some embodiments, each virtual NPU module 416-A, 416-B may provide to a corresponding network controller device in each core network 216-1, 216-2 functionality that includes translation of packet payload information between a first packet format for each of the network controller devices and a second packet format for one or more corresponding small cells.

Each of the small cells 214-1, 214-2 may include components such as a baseband processor (BBP), radio frequency integrated circuit (RFIC), a radio frequency front end (RFFE), and other components such as internal communication links, power supply, etc. (not illustrated). Each small cell 214-1, 214-2 may utilize the functions of the shared NPU 202. Thus, each of the other components of the small cells 214-1, 214-2 may be reduced in size and/or complexity.

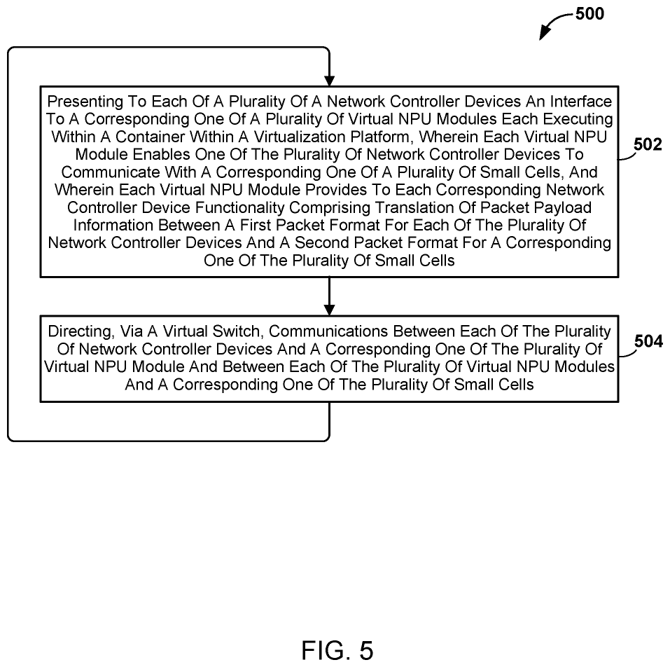

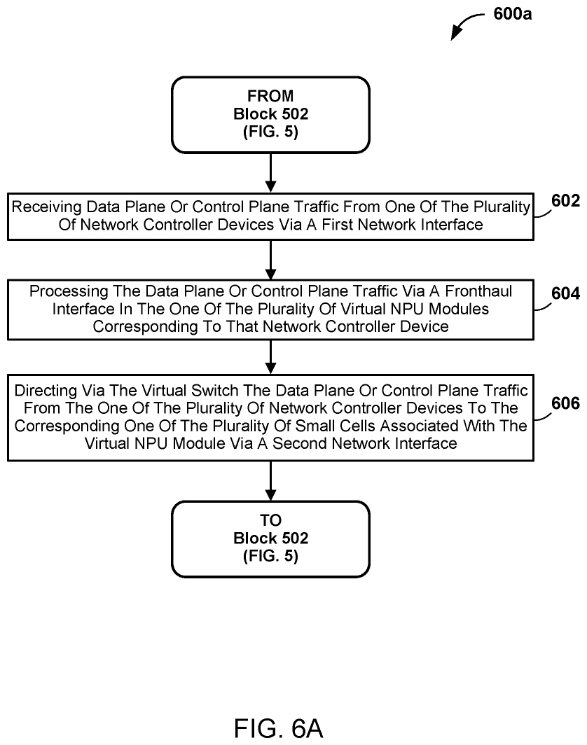

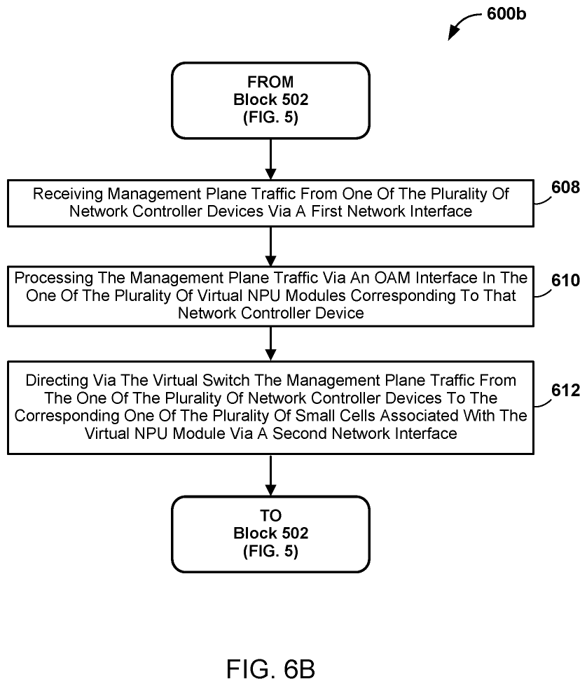

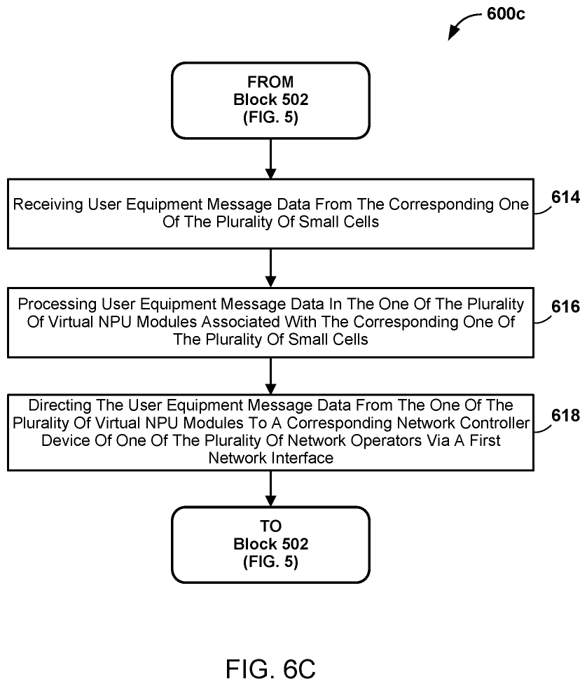

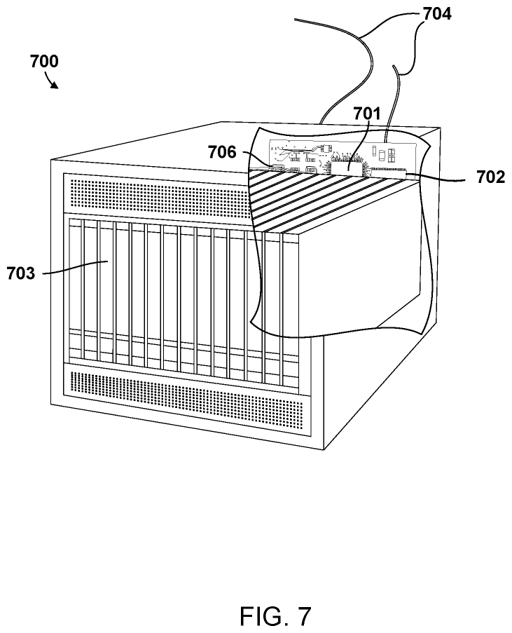

FIG. 5 is a process flow diagram illustrating a method 500 performed by a processor of a network processing unit (NPU) for managing communications according to various embodiments. With reference to FIGS. 1-5, the operations of the method 500 may be performed by a processor (e.g., 701, FIG. 7) of an NPU (e.g., the shared NPU 202).

In block 502, the processor may present to each of a plurality of network controller devices an interface to a corresponding one of a plurality of virtual NPU modules each executing within a container within (or on) a virtualization platform. In some embodiments, a network controller device may include a network element of a core network (e.g., 216-1, 216-2). In some embodiments, each virtual NPU module (e.g., 206-1, 206-2, 418-A, 418-B) may enable one of the plurality of network controller devices to communicate with a corresponding one of a plurality of small cells. In some embodiments, each virtual NPU module may provide to each corresponding network controller device functionality that includes translation of packet payload information between a first packet format for each of the plurality of network controller devices and a second packet format for a corresponding one of the plurality of small cells. In some embodiments, means for performing the operations of block 502 may include the processor 701 and the interface 704 (FIG. 7).

In block 504, the processor may direct, via a virtual switch, communications between each of the plurality of network controller devices and a corresponding one of the plurality of virtual NPU module and between each of the plurality of virtual NPU modules and a corresponding one of the plurality of small cells. In some embodiments, means for performing the operations of block 504 may include the processor 701 and the interface 704 (FIG. 7).

The processor may repeat the operations of blocks 502 and 504 from time to time.

FIGS. 6A, 6B, and 6C are process flows diagrams illustrating operations 600a, 600b, and 600c that may be performed by a processor (e.g., 701) of an NPU (e.g., 202) as part of the method 500 for managing communications according to various embodiments.

Referring to FIG. 6A, following the performance of block 502 of the method 500 (FIG. 5), the processor may receive data plane or control plane traffic from one of the plurality of network controller devices via a first network interface in block 602. For example, the processor may receive data plane or control plane traffic from a network controller device of a core network (e.g., 216-1. 216-2) via a communication network physical interface (e.g., 404). In some embodiments, means for performing the operations of block 602 may include the processor 701 and the interface 704 (FIG. 7).

In block 604, the processor may process the data plane or control plane traffic via a fronthaul interface in the one of the plurality of virtual NPU modules corresponding to that network controller device. For example, the processor may process the data plane or control plane traffic that is conveyed via the fronthaul interface (e.g., 412-A, 412-B) in a virtual NPU module (e.g., 206-1, 206-2, 418-A, 418-B). In some embodiments, means for performing the operations of block 602 may include the processor 701.

In block 606, the processor may direct via the virtual switch the processed message data or control information from the one of the plurality of network controller devices to the corresponding one of the plurality of small cells associated with the virtual NPU module via a second network interface. For example, the processor may send the processed message data or control information from the virtual NPU module (e.g., 206-1, 206-2, 418-A, 418-B) to a small cell (e.g., 214-1, 214-2) via a small cell physical interface (e.g., 402). In some embodiments, the processor may direct the message data or control information to the corresponding one of the plurality of small cells via a corresponding fronthaul interface (e.g., 416-A, 416-B). In some embodiments, means for performing the operations of block 602 may include the processor 701 and the interface 704 (FIG. 7).

The processor may proceed to perform the operations of block 502 (FIG. 5).

Referring to FIG. 6B, following the performance of block 502 of the method 500 (FIG. 5), the processor may receive management plane traffic from one of the plurality of network controller devices via a first network interface in block 608. For example, the processor may receive management plane traffic from a network controller device of a core network (e.g., 216-1. 216-2) via a communication network physical interface (e.g., 404). In some embodiments, means for performing the operations of block 602 may include the processor 701 and the interface 704 (FIG. 7).

In block 610, the processor may process the management plane traffic via an OAM interface (e.g., 412-A, 412-B) in the one of the plurality of virtual NPU modules corresponding to that network controller device. For example, the processor may process the message data or control information in a virtual NPU module (e.g., 206-1, 206-2, 418-A, 418-B). In some embodiments, means for performing the operations of block 602 may include the processor 701.

In block 612, the processor may direct via the virtual switch the management plane traffic from the one of the plurality of network controller devices to the corresponding one of the plurality of small cells associated with the virtual NPU module via a second network interface. For example, the processor may send the processed message data or control information from the virtual NPU module (e.g., 206-1, 206-2, 418-A, 418-B) to a small cell (e.g., 214-1, 214-2) via a small cell physical interface (e.g., 402). In some embodiments, the processor may direct the message data or control information to the corresponding one of the plurality of small cells via a corresponding fronthaul interface (e.g., 416-A, 416-B). In some embodiments, means for performing the operations of block 602 may include the processor 701 and the interface 704 (FIG. 7).

The processor may proceed to perform the operations of block 502 (FIG. 5).

Referring to FIG. 6C, following the performance of block 502 of the method 500 (FIG. 5), the processor may receive user equipment message data from the corresponding one of the plurality of small cells in block 614. For example, the processor may receive user equipment message data from a small cell (e.g., 214-1, 214-2) via a small cell physical interface (e.g., 402). In some embodiments, means for performing the operations of block 614 may include the processor 701 and the interface 704 (FIG. 7).

In block 616, the processor may process the user equipment message data in the one of the plurality of virtual NPU modules associated with the corresponding one of the plurality of small cells. In some embodiments, means for performing the operations of block 616 may include the processor 701 (FIG. 7).

In block 618, the processor may direct the user equipment message data from the one of the plurality of virtual NPU modules to the corresponding one of the plurality of network controller devices via a first network interface. For example, the processor may direct the user equipment message data from the one of the plurality of virtual NPU modules 418-A, 418-B to the corresponding one of the plurality of network controller devices (e.g., in a core network 216-1, 216-2) via the first network interface (e.g., the communication network physical interface 404). In some embodiments, means for performing the operations of block 602 may include the processor 701 and the interface 704 (FIG. 7). In some embodiments, means for performing the operations of block 618 may include the processor 701 and the interface 704 (FIG. 7).

Various embodiments, including the method 500 and the operations 600a and 600b, may be performed in a variety of network computing devices (e.g., in a base station), an example of which is illustrated in FIG. 7 that is a component block diagram of a network computing device 700 suitable for use with various embodiments. Such network computing devices may include at least the components illustrated in FIG. 7. With reference to FIGS. 1-7, a network computing device 700 may include a processor 701 coupled to volatile memory 702 and a large capacity nonvolatile memory, such as a disk drive 703. The network computing device 700 may also include a peripheral memory access device such as a floppy disc drive, compact disc (CD) or digital video disc (DVD) drive 706 coupled to the processor 701. The network computing device 700 may also include network access ports or interfaces 704 coupled to the processor 701 for establishing data connections with a network, such as the Internet and/or a local area network coupled to other system computers and servers. The network computing device 700 may be connected to one or more antennas for sending and receiving electromagnetic radiation that may be connected to a wireless communication link. The network computing device 700 may include additional access ports, such as USB, Firewire, Thunderbolt, and the like for coupling to peripherals, external memory, or other devices.

The processor 701 of the network computing device 700 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within a system-on-chip dedicated to wireless communication functions and one processor within a system-on-chip dedicated to running other applications. Software applications may be stored in the memory 702, 703 before they are accessed and loaded into the processor. The processors may include internal memory sufficient to store the application software instructions.

Implementation examples are described in the following paragraphs. While some of the following implementation examples are described in terms of an example shared network processing unit including a first network port, a second network port, and a processor configured with processor-executable instructions to perform operations of the following implementation examples, and in terms of example methods, further example implementations may include: the example methods discussed in the following paragraphs implemented as a non-transitory processor-readable medium having stored thereon processor-executable instruction configured to cause a processing device in a shared network processing unit to perform operations of the methods of the following implementation examples, and a shared network processing unit comprising means for performing functions of the methods of the following implementation examples.

Example 1. A shared network processing unit, including: a first network port configured to provide a first network interface for data and command messages to a plurality of network operators, a second network port configured to provide a second network interface for data and command messages to each of a plurality of small cells, and a processor configured with processor-executable instructions to perform operations comprising, providing a virtualization platform coupled to the first and second network ports, executing a plurality of virtual network processing unit (NPU) modules, each of the plurality of virtual NPU modules providing network processing unit functionality for a corresponding one of the plurality of network operators, wherein each of the plurality of virtual NPU modules executes within a container within the virtualization platform, and wherein the network processing unit functionality includes translation of packet payload information between a first packet format for each of the plurality of network operators and a second packet format for a corresponding one of the plurality of small cells, and executing a virtual switch configured to pass message data and control information between each of the plurality of network operators and a corresponding one of the plurality of network processing unit modules via the first network interface and to pass message data and control information between each of the plurality of network processing unit modules and a corresponding one of a plurality of small cells via the second network interface.

Example 2. The shared network processing unit of example, 1, wherein the processor is further configured with processor-executable instructions to perform operations such that executing each of the plurality of network processing unit modules includes executing an operations, administration and management (OAM) interface configured to convey management plane traffic between a corresponding network operator and a corresponding small cell, and executing a fronthaul interface configured to convey data plane and control plane traffic between the corresponding network operator and the corresponding small cell.

Example 3. The shared network processing unit of example 2, wherein the processor is further configured with processor-executable instructions to perform operations such that each fronthaul interface and OAM interface executes within a container within the virtualization platform.

Example 4. The shared network processing unit of any of examples 1-3, wherein the first network port is an Ethernet port configured to be coupled to a plurality of network operators via an external network.

Example 5. The shared network processing unit of any of examples 1-4, wherein the second network port is at least one PCIe port configured to be coupled to a plurality of small cells.

Example 6. The shared network processing unit of any of examples 1-5, wherein the processor is further configured with processor-executable instructions to perform operations including receiving data plane or control plane traffic from one of the plurality of network operators via the first network interface, processing the data plane or control plane traffic via the fronthaul interface in one of the plurality of virtual NPU modules corresponding to that network operator, and directing via the virtual switch the data or control plane traffic from the one of the plurality of network operators to the corresponding one of the plurality of small cells associated with the virtual NPU module via the second network interface.

Example 7. The shared network processing unit of any of examples 1-6, wherein the processor is further configured with processor-executable instructions to perform operations including, receiving management plane traffic from one of the plurality of network operators via the first network interface, processing the management plane traffic via the OAM interface in one of the plurality of virtual NPU modules corresponding to that network operator, and directing via the virtual switch the data or control plane traffic from the one of the plurality of network operators to the corresponding one of the plurality of small cells associated with the virtual NPU module via the second network interface.

Example 8. The shared network processing unit of any of examples 1-7, wherein the processor is further configured with processor-executable instructions to perform operations including receiving user equipment message data from the corresponding one of the plurality of small cells, processing the user equipment message data in the one of the plurality of virtual NPU modules associated with the corresponding one of the plurality of small cells, and directing the user equipment message data from the one of the plurality of virtual NPU modules to a corresponding network controller device of one of the plurality of network operators via the first network interface.

Example 9. A method of managing communications performed by a shared network processing unit (NPU), including presenting to each of a plurality of network controller devices an interface to a corresponding one of a plurality of virtual NPU modules each executing within a container within a virtualization platform, wherein each virtual NPU module enables one of the plurality of network controller devices to communicate with a corresponding one of a plurality of small cells, and wherein each virtual NPU module provides to each corresponding network controller device functionality comprising translation of packet payload information between a first packet format for each of the plurality of network controller devices and a second packet format for a corresponding one of the plurality of small cells, and directing, via a virtual switch, communications between each of the plurality of network controller devices and a corresponding one of the plurality of virtual NPU module and between each of the plurality of virtual NPU modules and a corresponding one of the plurality of small cells.

Example 10. The method of example 9, wherein directing, via a virtual switch, communications between each of the plurality of network controller devices and the corresponding one of the plurality of virtual NPU module and between each of the plurality of virtual NPU modules and the corresponding one of the plurality of small cells includes receiving data plane or control plane traffic from one of the plurality of network controller devices via a first network interface, processing the data plane or control plane traffic via a fronthaul interface in the one of the plurality of virtual NPU modules corresponding to that network controller device, and directing via the virtual switch the data plane or control plane traffic from the one of the plurality of network controller devices to the corresponding one of the plurality of small cells associated with the virtual NPU module via a second network interface.

Example 11. The method of any of examples 9 and 10, wherein directing, via the virtual switch, communications between each of the plurality of network controller devices and the corresponding one of the plurality of virtual NPU modules and between each of the plurality of virtual NPU modules and the corresponding one of the plurality of small cells further includes receiving management plane traffic from one of the plurality of network controller devices via a first network interface, processing the management plane traffic via an operations, administration and management (OAM) interface in the one of the plurality of virtual NPU modules corresponding to that network controller device, and directing via the virtual switch the management plane traffic from the one of the plurality of network controller devices to the corresponding one of the plurality of small cells associated with the virtual NPU module via a second network interface.

Example 12. The method of any of examples 9-11, wherein directing, via the virtual switch, communications between each of the plurality of network controller devices and the corresponding one of the plurality of virtual NPU modules and between each of the plurality of virtual NPU modules and the corresponding one of the plurality of small cells further includes receiving user equipment message data from the corresponding one of the plurality of small cells, processing user equipment message data in the one of the plurality of virtual NPU modules associated with the corresponding one of the plurality of small cells, and directing the user equipment message data from the one of the plurality of virtual NPU modules to the corresponding one of the plurality of network controller devices via a first network interface.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500, 600a, and 600b may be substituted for or combined with one or more operations of the methods 500, 600a, and 600b.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A shared network processing unit, comprising:
a first network port configured to provide a first network interface for data and command messages to a plurality of network operators;
a second network port configured to provide a second network interface for data and command messages to each of a plurality of small cells; and
a processor configured with processor-executable instructions to perform operations comprising:
providing a virtualization platform coupled to the first and second network ports;
executing a plurality of virtual network processing unit (NPU) modules, each of the plurality of virtual NPU modules providing network processing unit functionality for a corresponding one of the plurality of network operators, wherein each of the plurality of virtual NPU modules executes within a container within the virtualization platform, and wherein the network processing unit functionality comprises translation of packet payload information between a first packet format for each of the plurality of network operators and a second packet format for a corresponding one of the plurality of small cells; and
executing a virtual switch configured to pass message data and control information between each of the plurality of network operators and a corresponding one of the plurality of network processing unit modules via the first network interface and to pass message data and control information between each of the plurality of network processing unit modules and a corresponding one of a plurality of small cells via the second network interface.

2. The shared network processing unit of claim 1, wherein the processor is further configured with processor-executable instructions to perform operations such that executing each of the plurality of network processing unit modules comprises:
executing an operations, administration and management (OAM) interface configured to convey management plane traffic between a corresponding network operator and a corresponding small cell; and
executing a fronthaul interface configured to convey data plane and control plane traffic between the corresponding network operator and the corresponding small cell.

3. The shared network processing unit of claim 2, wherein the processor is further configured with processor-executable instructions to perform operations such that each fronthaul interface and OAM interface executes within a container within the virtualization platform.

4. The shared network processing unit of claim 1, wherein the first network port is an Ethernet port configured to be coupled to a plurality of network operators via an external network.

5. The shared network processing unit of claim 1, wherein the second network port is at least one PCIe port configured to be coupled to a plurality of small cells.

6. The shared network processing unit of claim 1, wherein the processor is further configured with processor-executable instructions to perform operations comprising:
receiving data plane or control plane traffic from one of the plurality of network operators via the first network interface;
processing the data plane or control plane traffic via a fronthaul interface in one of the plurality of virtual NPU modules corresponding to that network operator; and
directing via the virtual switch the data or control plane traffic from the one of the plurality of network operators to the corresponding one of the plurality of small cells associated with the virtual NPU module via the second network interface.

7. The shared network processing unit of claim 1, wherein the processor is further configured with processor-executable instructions to perform operations comprising:
receiving management plane traffic from one of the plurality of network operators via the first network interface;
processing the management plane traffic via an operations, administration and management (OAM) interface in one of the plurality of virtual NPU modules corresponding to that network operator; and
directing via the virtual switch the data or control plane traffic from the one of the plurality of network operators to the corresponding one of the plurality of small cells associated with the virtual NPU module via the second network interface.

8. The shared network processing unit of claim 1, wherein the processor is further configured with processor-executable instructions to perform operations comprising:
receiving user equipment message data from the corresponding one of the plurality of small cells;
processing the user equipment message data in the one of the plurality of virtual NPU modules associated with the corresponding one of the plurality of small cells; and
directing the user equipment message data from the one of the plurality of virtual NPU modules to a corresponding network controller device of one of the plurality of network operators via the first network interface.

9. A method of managing communications performed by a shared network processing unit (NPU), comprising:
presenting to each of a plurality of network controller devices an interface to a corresponding one of a plurality of virtual NPU modules each executing within a container within a virtualization platform, wherein each virtual NPU module enables one of the plurality of network controller devices to communicate with a corresponding one of a plurality of small cells, and wherein each virtual NPU module provides to each corresponding network controller device functionality comprising translation of packet payload information between a first packet format for each of the plurality of network controller devices and a second packet format for a corresponding one of the plurality of small cells; and
directing, via a virtual switch, communications between each of the plurality of network controller devices and a corresponding one of the plurality of virtual NPU modules and between each of the plurality of virtual NPU modules and a corresponding one of the plurality of small cells.

10. The method of claim 9, wherein directing, via a virtual switch, communications between each of the plurality of network controller devices and the corresponding one of the plurality of virtual NPU modules and between each of the plurality of virtual NPU modules and the corresponding one of the plurality of small cells comprises:
receiving data plane or control plane traffic from one of the plurality of network controller devices via a first network interface;
processing the data plane or control plane traffic via a fronthaul interface in the one of the plurality of virtual NPU modules corresponding to that network controller device; and
directing via the virtual switch the data plane or control plane traffic from the one of the plurality of network controller devices to the corresponding one of the plurality of small cells associated with the virtual NPU module via a second network interface.

11. The method of claim 9, wherein directing, via the virtual switch, communications between each of the plurality of network controller devices and the corresponding one of the plurality of virtual NPU modules and between each of the plurality of virtual NPU modules and the corresponding one of the plurality of small cells further comprises:
receiving management plane traffic from one of the plurality of network controller devices via a first network interface;
processing the management plane traffic via an operations, administration and management (OAM) interface in the one of the plurality of virtual NPU modules corresponding to that network controller device; and
directing via the virtual switch the management plane traffic from the one of the plurality of network controller devices to the corresponding one of the plurality of small cells associated with the virtual NPU module via a second network interface.

12. The method of claim 9, wherein directing, via the virtual switch, communications between each of the plurality of network controller devices and the corresponding one of the plurality of virtual NPU modules and between each of the plurality of virtual NPU modules and the corresponding one of the plurality of small cells further comprises:
receiving user equipment message data from the corresponding one of the plurality of small cells;
processing user equipment message data in the one of the plurality of virtual NPU modules associated with the corresponding one of the plurality of small cells; and
directing the user equipment message data from the one of the plurality of virtual NPU modules to the corresponding one of the plurality of network controller devices via a first network interface.

13. A non-transitory processor-readable medium having stored thereon processor-executable instruction configured to cause a processing device in a shared network processing unit (NPU) to perform operations comprising:
presenting to each of a plurality of network controller devices an interface to a corresponding one of a plurality of virtual NPU modules each executing within a container within a virtualization platform, wherein each virtual NPU module enables one of the plurality of network controller devices to communicate with a corresponding one of a plurality of small cells, and wherein each virtual NPU module provides to each corresponding network controller device functionality comprising translation of packet payload information between a first packet format for each of the plurality of network controller devices and a second packet format for a corresponding one of the plurality of small cells; and
directing, via a virtual switch, communications between each of the plurality of network controller devices and a corresponding one of the plurality of virtual NPU modules and between each of the plurality of virtual NPU modules and a corresponding one of the plurality of small cells.

14. The non-transitory processor-readable medium of claim 13, wherein the stored processor-executable instructions are further configured to cause a processor of a wireless device to perform operations such that directing, via a virtual switch, communications between each of the plurality of network controller devices and the corresponding one of the plurality of virtual NPU modules and between each of the plurality of virtual NPU modules and the corresponding one of the plurality of small cells comprises:
receiving data plane or control plane traffic from one of the plurality of network controller devices via a first network interface;
processing the data plane or control plane traffic via a fronthaul interface in the one of the plurality of virtual NPU modules corresponding to that network controller device; and
directing via the virtual switch the data plane or control plane traffic from the one of the plurality of network controller devices to the corresponding one of the plurality of small cells associated with the virtual NPU module via a second network interface.

15. The non-transitory processor-readable medium of claim 13, wherein the stored processor-executable instructions are further configured to cause a processor of a wireless device to perform operations such that directing, via the virtual switch, communications between each of the plurality of network controller devices and the corresponding one of the plurality of virtual NPU modules and between each of the plurality of virtual NPU modules and the corresponding one of the plurality of small cells further comprises:
receiving management plane traffic from one of the plurality of network controller devices via a first network interface;
processing the management plane traffic via an operations, administration and management (OAM) interface in the one of the plurality of virtual NPU modules corresponding to that network controller device; and
directing via the virtual switch the management plane traffic from the one of the plurality of network controller devices to the corresponding one of the plurality of small cells associated with the virtual NPU module via a second network interface.

16. The non-transitory processor-readable medium of claim 13, wherein the stored processor-executable instructions are further configured to cause a processor of a wireless device to perform operations such that directing, via the virtual switch, communications between each of the plurality of network controller devices and the corresponding one of the plurality of virtual NPU modules and between each of the plurality of virtual NPU modules and the corresponding one of the plurality of small cells further comprises:
receiving user equipment message data from the corresponding one of the plurality of small cells;
processing user equipment message data in the one of the plurality of virtual NPU modules associated with the corresponding one of the plurality of small cells; and
directing the user equipment message data from the one of the plurality of virtual NPU modules to the corresponding one of the plurality of network controller devices via a first network interface.

17. A shared network processing unit, comprising:
means for presenting to each of a plurality of network controller devices an interface to a corresponding one of a plurality of virtual NPU modules each executing within a container within a virtualization platform, wherein each virtual NPU module enables one of the plurality of network controller devices to communicate with a corresponding one of a plurality of small cells, and wherein each virtual NPU module provides to each corresponding network controller device functionality comprising translation of packet payload information between a first packet format for each of the plurality of network controller devices and a second packet format for a corresponding one of the plurality of small cells; and
means for directing, via a virtual switch, communications between each of the plurality of network controller devices and a corresponding one of the plurality of virtual NPU module and between each of the plurality of virtual NPU modules and a corresponding one of the plurality of small cells.

18. The shared network processing unit of claim 17, wherein means for directing, via a virtual switch, communications between each of the plurality of network controller devices and the corresponding one of the plurality of virtual NPU modules and between each of the plurality of virtual NPU modules and the corresponding one of the plurality of small cells comprises:
means for receiving data plane or control plane traffic from one of the plurality of network controller devices via a first network interface;
means for processing the data plane or control plane traffic via a fronthaul interface in the one of the plurality of virtual NPU modules corresponding to that network controller device; and
means for directing via the virtual switch the data plane or control plane traffic from the one of the plurality of network controller devices to the corresponding one of the plurality of small cells associated with the virtual NPU module via a second network interface.

19. The shared network processing unit of claim 17, wherein means for directing, via the virtual switch, communications between each of the plurality of network controller devices and the corresponding one of the plurality of virtual NPU modules and between each of the plurality of virtual NPU modules and the corresponding one of the plurality of small cells further comprises:
means for receiving management plane traffic from one of the plurality of network controller devices via a first network interface;
means for processing the management plane traffic via an operations, administration and management (OAM) interface in the one of the plurality of virtual NPU modules corresponding to that network controller device; and
means for directing via the virtual switch the management plane traffic from the one of the plurality of network controller devices to the corresponding one of the plurality of small cells associated with the virtual NPU module via a second network interface.

20. The shared network processing unit of claim 17, wherein means for directing, via the virtual switch, communications between each of the plurality of network controller devices and the corresponding one of the plurality of virtual NPU modules and between each of the plurality of virtual NPU modules and the corresponding one of the plurality of small cells further comprises:
means for receiving user equipment message data from the corresponding one of the plurality of small cells;
means for processing user equipment message data in the one of the plurality of virtual NPU modules associated with the corresponding one of the plurality of small cells; and
means for directing the user equipment message data from the one of the plurality of virtual NPU modules to the corresponding one of the plurality of network controller devices via a first network interface.
